(19) United States
(12) Patent Application Publication
(10) Pub. No.: US 2007/0252001 A1
(43) Pub. Date: Nov. 1, 2007

(54) Access control system with RFID and biometric facial recognition

(76) Inventors: Kevin J. Kail, Great Falls, VA (US); Charles B. Williams, South Riding, VA (US); Richard L. Kail, Wayzata, MN (US)

Correspondence Address: JOHN S. HALE;GIPPLE & HALE, 6665-A OLD DOMINION DRIVE, MCLEAN, VA, 22101, US

(21) Appl. No.: 11/790,385

(22) Filed: Apr. 25, 2007

Related U.S. Application Data
(60) Provisional application No. 60/794,505, filed on Apr. 25, 2006.

(51) Int. Cl. G06K 5/00

(52) U.S. Cl. 235/380

(57) ABSTRACT

A biometric identification system which uses a UHF radio frequency identification (RFID) tag storing a first set of specified biometric information on an identity card; which bears a facial picture of the card carrier. An identification system comprising an antenna using radio frequency signals and a reader is used to read the first set of specified biometric information from the tag when the identify card is within sensing range of the identification system. A camera captures and digitalizes the facial features of the card carrier when the card carrier approaches a designated area and transmits this digital data to a computer which compares the first set of specified biometric information obtained by the reader from the identity card and the second set of digital facial information obtained from the camera to the stored biometric information to determine if the two sets of biometric information are a match.

### RELATED APPLICATIONS

There are no related applications.

### STATEMENT REGARDING FEDERALLY SPONSORED RESEARCH OR DEVELOPMENT

Not applicable.

### REFERENCE TO SEOUENCE LISTING, A TABLE OR A COMPUTER PROGRAM LISTING COMPACT DISC APPENDIX

None.

### FIELD OF TIE INVENTION

The present invention generally relates to access control badges with RFID tags embedded in them matched to biometric information of the person carrying the badge.

### BACKGROUND OF THE INVENTION

A door with a latching mechanism was initially used to control access to a room or building and later security was provided by a lock and key mechanism. Security progressed with electromechanical devices which provided the ability to gain access to a building via a door/entry point, by pressing a button/switch, and completing the circuit, which activated the electric motor to disengage the latching mechanism controlling the door.

Card readers were introduced in the early 1930's and used punch cards. In the 1950's magnetic stripe readers and HF close proximity readers were included as part of the access control systems. These systems helped lessen the need for guards.

Guards have been used to control access throughout the history of access control. They made the decision to allow or disallow access thru the door/entry point of a building and were the eyes and ears of access control.

In the 1970's, cameras began to provide an electronic set of eyes. This meant that a human was not required to be at every location. Instead a single human could monitor multiple locations at the same time. Over time, access control systems have shifted from physical systems of locks and keys to logical systems where a single controller/security station can monitor many locations.

The security market has historically lagged behind computing and communications technology developments. However, recent events have driven up the priority on security in general, and access control specifically. The two worlds of IT and security are now touching, and the security industry is now utilizing the technology infusion that customers demand, and integrators desire to differentiate their product offerings. For high security access points, the traditional security pillars of CCTV, intercom and access control have historically coexisted as components of a fragmented system, using primarily analog signals, with only crude interfaces that do not allow for the exploitation of proper system integration.

The prevailing wisdom within the security community is that facial recognition (FR) will need to be featured prominently in the growth and maturity of access control market. There is a need for the security of biometric access control, low ownership cost and the reliability of digital video based on a CCTV system.

Electronic article surveillance (“EAS”) systems detect the presence of small electronic devices placed on or in an article or carried by a person of interest, and are often used in retail or library environments to deter theft or other unauthorized removal of articles. These devices, which are commonly known as tags or markers, have typically contained only information regarding the presence of an item. This information could be obtained by electronically interrogating the tag, either intermittently or continuously. Examples of EAS systems including the following: U.S. Pat. No. 4,260,990; U.S. Pat. No. 4,251,808; U.S. Pat. No. 4,872,018; U.S. Pat. No. 4,135,183; U.S. Pat. No. 6,081,238.

Radio-Frequency Identification (RFID) technology has become widely used in virtually every industry, including transportation, manufacturing, waste management, postal tracking, airline baggage reconciliation, and highway toll management. A typical RFID system includes a plurality of RFID tags, at least one RFID reader or detection system having an antenna for communication with the RFID tags, and a computing device to control the RFID reader. The RFID reader includes a transmitter that may provide information to the tags, and a receiver to receive identity and other information from the tags. The computing device processes the information obtained by the RFID reader. Examples of RFID antenna systems or non-contact integrated circuit reader/writer systems including the following: U.S. Patent Publication Number 2003/0063034; Japanese Patent Publication Number 2003-347830; Japanese Patent Publication Number 2000-036019; and U.S. Pat. No. 6,163,305.

All passengers entering the USA have been required to bring a Machine Readable Travel Document (MTRD), i.e. a machine-readable passport since October 2003. In October 2004, the passport was required to contain biometric data that uniquely identified the bearer. This turns the passport into a “smart” passport, which comprises a contactless chip that stores the personal biometric information as digital information. The chip is accessed contactlessly by a reader that retrieves the biometric information and compares it with information stored in a database, to verify the identity of the passport bearer.

Smart documents are known in the art. Smart cards have been used to store personal information and even biometric information about their owners to facilitate electronic transactions. The information is stored on embedded chips, see for example U.S. Pat. No. 6,219,439, the content of which is incorporated herein by reference, U.S. Pat. No. 6,219,439 further describes a identifying characteristic authentication system using a smart card having stored physiological data of a user on a chip disposed therein, and a fingerprint scan (or retina scan, voice identification, saliva or other identifying characteristic data) for comparison against the stored data. The system is self-contained so that the comparison of the identifying characteristic data with the data stored on the chip is done immediately by the reader without relying upon communications to or from an external source in order to authenticate the user. This arrangement also prevents communication with external sources prior to user authentication being confirmed, so as to prevent user data from being stolen or corrupted.

U.S. Pat. No. 6,101,477 describes a smart card for travel-related use, such as for airline, hotel, rental car, and payment-related applications. Memory space and security features within specific applications provide partnering organizations (e.g., airlines, hotel chains, and rental car agencies) the ability to construct custom and secure file structures. U.S. Pat. No. 5,291,560 describes a personal identification system based on iris analysis. U.S. Pat. No. 5,363,453 describes a personal identification system based on biometric fingerprint data.

Facial identification systems are disclosed in International Patent Application publications WO 00/62474 published Oct. 19, 2000, and WO 02/09024 A1 published on Jan. 31, 2002. In WO 00/62474, a computer uses a facial biometric template to encode a document. In WO 02/09024 A1, a facial identification matrix is obtained. 2D and 3D biometric templates are created from a single camera and the facial index data is extracted. These published applications are incorporated herein by reference.

The weakness in access control systems today is that most of them rely on a human to catch and subsequently process exceptional conditions such as tailgating (multiple people walking through a secured location at the same time using only one ID badge to open the door) and buddy badging (having one person log two badges in the system when only one person enters the zone). Given human nature and the repetitive nature of access control systems, it is almost impossible to have a human be responsible for catching all of the exceptional cases. Guards, cameras and access control cards (and any combination of them) are used to add additional levels of security to current systems. Yet, these systems are still far from perfect.

The invention is directed to the next-generation access control system. RFID technology allows for the creation of new RFID-based ID badges. These badges can be read at a rate of 1500 times per minute and can be read at distances of up to twenty feet. Adding additional antennae can increase the distance at which these ID badges are read. Combining the RFID ID badge with certain biometric facial recognition features provides additional data to ensure that the proper person is carrying the proper ID badge. The addition of high resolution video technology that can read faces at 40 feet in order to provide facial biometric data adds the additional time and distance to allow the system to catch exceptions to the security rules which in turn provides more accurate data to the human in the loop, thus providing a more robust access control system.

### SUMMARY OF THE INVENTION

The present invention employs UHF RFID technology, combined with biometric recognition to provide the basis for the access control systems. The invention integrates RFID data from an ID badge with biometric data about the person to whom the badge belongs to in order to ensure proper identification of an individual by being able to match a RFID read with a picture of a face taken at a security zone or station.

The invention additionally provides the ability to create UHF RFID ID badges and enroll the badge holder into the biometric recognition database. Enrolling a badge holder into the database extracts biometric features from digital images taken as part of the ID badge creation process and stores the facial features to be matched with digital images taken during operation of the access control system at a security zone or station. Once the ID badge is created, information about the badge holder including their biometric data is stored by the invention.

In the operation of the invention, RFID readers read ID badges, security cameras take digital images and match the RFID reads to the images according to the data stored is a database during the creation of the ID badge. If the system matches all the RFID reads of the ID badges with the facial details in the digital image, then no action is taken and the system grants access to the badge holder. If the face is independently matched but no matching ID badge is read an exception is logged. If the ID badge is read and no face is found an exception is also logged. In order to ensure that the correct number of badges and faces are found, the invention tracks the people found in the frame. For example, if four people are counted in the frame, then four badges must be seen by the RFID reader and four faces must be found by the biometric details and the four badges must match the four faces.

It is an object of the invention to provide a security identification system which matches a person's captured facial data with stored facial data having a specific RFID identification.

### BRIEF DESCRIPTION OF TIHE DRAWINGS

The invention will be better understood and objects other than those set forth above will become apparent when consideration is given to the following detailed description thereof. Such description makes reference to the annexed drawings wherein:

FIG. 1 is a schematic showing a system in accordance with the invention.

FIG. 2 is a schematic flowchart showing equipment setup and configuration.

FIG. 3 is a schematic flowchart showing the creation of an ID badge.

FIG. 4 is a schematic flowchart showing how a system in accordance with the invention monitors a security zone or access control point.

### DETAILED DESCRIPTION OF THE INVENTION

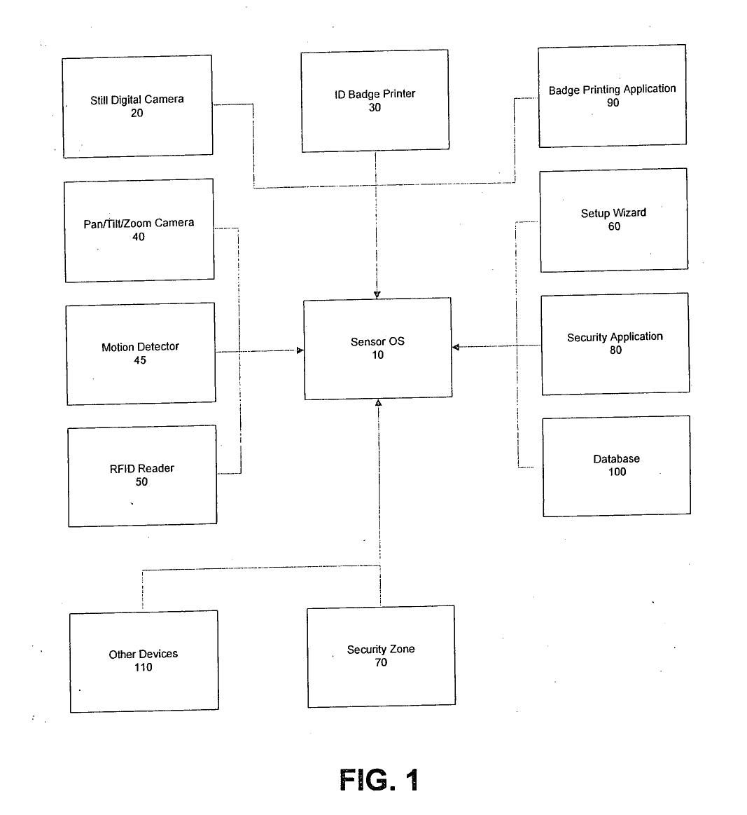

The preferred embodiment and best mode of the invention is shown in FIGS. 1 through 4. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

Documents of value such as passports, identification cards, entry passes, ownership certificates, financial instruments, and the like, are often assigned to a particular person by personalization data. Personalization data, often present as printed images, can include photographs, signatures, personal alphanumeric information, and barcodes, and allows human or electronic verification that the person presenting the document for inspection is the person to whom the document is assigned. Many countries have plans to include radio-frequency identification (“RFID”) elements in passports, with RFID elements carrying personalization data particular to the person carrying the passport. For example, the United States, some European countries, some Latin American countries, Canada, and Australia plan to issue passports having RFID elements in the near future.

An RFID element includes an integrated circuit (“IC”) or an RFID tag, which includes an IC and an antenna. When the identification card is presented at an entry point at a building or entrance, the readers will read the RFID element embedded inside the IC and read certain information, such as text, printed images, and the like printed on the IC. The information retrieved from the RFID element and the optical information previously recorded and also presented on the IC will then be processed by at least one computer, and based on that information, a person may be admitted to enter into facility or kept for further questioning or screening.

FIG. 1 discloses the architecture for a system that implements the methods for the present invention. The central component is the Sensor Operating System (SensorOS) 10. The SensorOS serves as the command and control center of the invention. It is responsible for managing the connections to all the other components, both hardware devices and software applications in the system. The hardware components include a still digital camera 20 such as Infinova IP Fixed Camera V1022N-L04, an ID badge card printer 30 such as Zebra P420i Card Printer, a pan/tilt/zoom (PTZ) IP video camera 40 such as Infinova V1700N Series IP Super Dome and an RFID reader 50 such as Symbol AR400/XR400 RFID reader. The above commercially available equipment is meant to be illustrative and does not exclude the many other types of equipment available in the marketplace

The PTZ camera may or may not include a motion detector 45. If the motion detector is not integrated into the camera then an external motion detector will be used. The SensorOS also monitors the status of all the connected devices and reports on any exceptional conditions with its connected devices.

The SensorOS is configured by the Setup Wizard 60. The Setup Wizard is a software program used to configure the connected devices with regards to their required operational attribute (i.e. IP address, name, location). The Setup Wizard is also used to define security zones or access control points 70. Each security zone or access control point is configured with at least one RFID reader and one PTZ video camera. The SensorOS receives requests from and sends events to the security application 80 and the ID badge printing application 90.

The Setup Wizard is a screen by screen, field by field program that is used to setup and configure all the physical devices required by the invention and all the logical security zones or access points that the invention will monitor. Each screen in the Setup Wizard is used to configure a different type of device. For the ID Badge Printer, the Setup Wizard asks for a logical name and the method that will be used to connect to the printer (USB or TCP/IP). If TCP/IP is selected, then the IP address and TCP/IP port of the printer are provided. The fixed IP camera includes the camera's IP address as well as the directory that will be used to store snapshots taken with the camera during regular operation of the device. The RFID Reader screen requires the reader's IP address and TCP/IP port as well as the number of antenna to be used and the power setting for each antenna. The PTZ Camera settings include the camera's IP address and whether or not the camera includes a built-in Motion Detector. The Motion Detector page asks for the motion detector's IP address and port.

After the hardware is configured, the Setup Wizard is then used to define the various stations where the system will be used. There are two types of stations, an ID Badge Printing Station and a Security Zone Station. Each type of station is given a logical name. If the station is an ID Badge Printing Station, then a Fixed IP camera and ID Badge Printer that have been previously configured are assigned to that station. If the station is a Security Zone Station, then PTZ or fixed IP cameras may be assigned as well as RFID Readers. At least one camera and one RFID reader are required for each Security Zone Station.

A database 100 is used to store information about the people with ID badges as well as the biometric facial attributes of those same people. Biometric facial information is also held in memory to provide for faster biometric matching. The ID badge printing application stores information in the database and enrolls the biometric facial information. The security application then accesses this information during the execution of the system in order to determine proper matching of the ID badge to the face of the person carrying the ID badge. If a positive match is made the system logs the matched event and executes the action associated with a positive match (for example unlocking the door being watched by the system). If a positive match is not made, the system logs the exception and displays the information to the user running the system. Additional rules for handling exceptions, if present, are also executed.

Other devices 110 used in the system such as a light stack and IP-based latch mechanisms can also be configured in the system. The light stack is used to provide visual feedback for exception conditions. In the present embodiment the light stack would typically turn green when the face matches and the tag matches, yellow when the tag matches but the face does not match (e.g. face covered with ski mask); blue when the face matches but the tag doesn't (tag left in car); red when person viewed didn't match face or tag. When either yellow, blue or red conditions occur the light stack flashes with an audio beep to alert security. Latch mechanisms can be used to automatically control access at an entry/exit location based on the exceptions. If an exception occurs the latch will remain closed, if no exception is detected then the latch can be automatically opened.

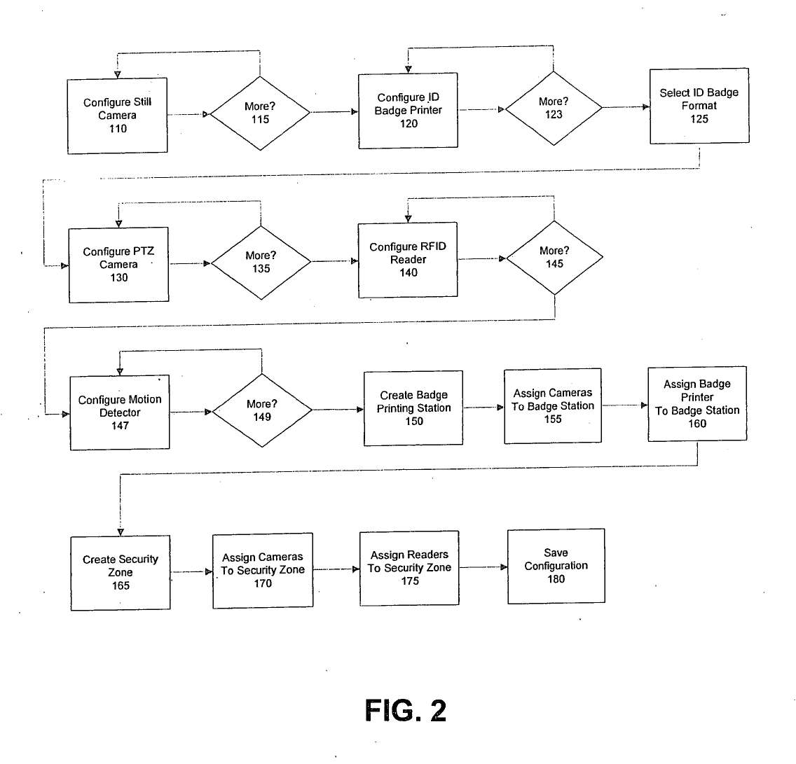

FIG. 2 shows the process that is used to configure the hardware devices used by the system. The first step in the process is to configure the still camera 110 used to take pictures for the ID badges. This requires identifying the directory where pictures taken with the still camera will appear. If there are more still cameras 115 to be configured the process is repeated, if not the next step is to configure the badge printer 120 used to print ID badges. This involves identifying the communications port (TCP/IP, serial or USB) that the host computer will use to send ID badge information to the printer. If there is more than one ID badge printer 123 the process is repeated. When there are no more badge printers to configure the next step is to identify the ID badge template 125 that will be used to create the ID badges. The next step is to configure the PTZ camera 130 to be used at the security zones. This requires specifying the PTZ camera manufacturer, the IP address of the PTZ camera and whether or not the PTZ camera includes a built-in motion detector. When no more PTZ cameras need to be configured 135 the next step is to configure the RFID reader 140. The RFID reader configuration requires an IP address, TCP/IP port and antenna configuration, including how many antennas will be used as well as the power setting for each antenna. If there are more RFID readers 145, the process is repeated. If the PTZ cameras being configured do not have a built-in motion detector and the user desires to use a motion detector, then the motion detectors are configured 147. Each motion detector requires an IP address. If there are additional motion detectors 149 then the process is repeated.

Once all the hardware devices are configured, the security zones need to be created and the proper equipment needs to be assigned to each zone. The first step in the process is to create the Badge Printing Station 150. The Badge Printing Station is given a logical name such as “Human Resource Office”. The Still Camera 155 and Badge Printer 160 are assigned to the Badge Printing Station. The next step in this process is to create the required Security Zones 170. Each zone is given a logical name, such as “Main Entrance”. Then for each zone, the PTZ camera(s) 175 for that are added and the RFID reader(s) 185 are added as well. It should be noted that if multiple PTZ cameras and RFID readers are assigned to a single security zone that the PTZ cameras and RFID readers work in combination as a single logical PTZ camera and RFID reader. Finally, all of the configuration information is saved 180.

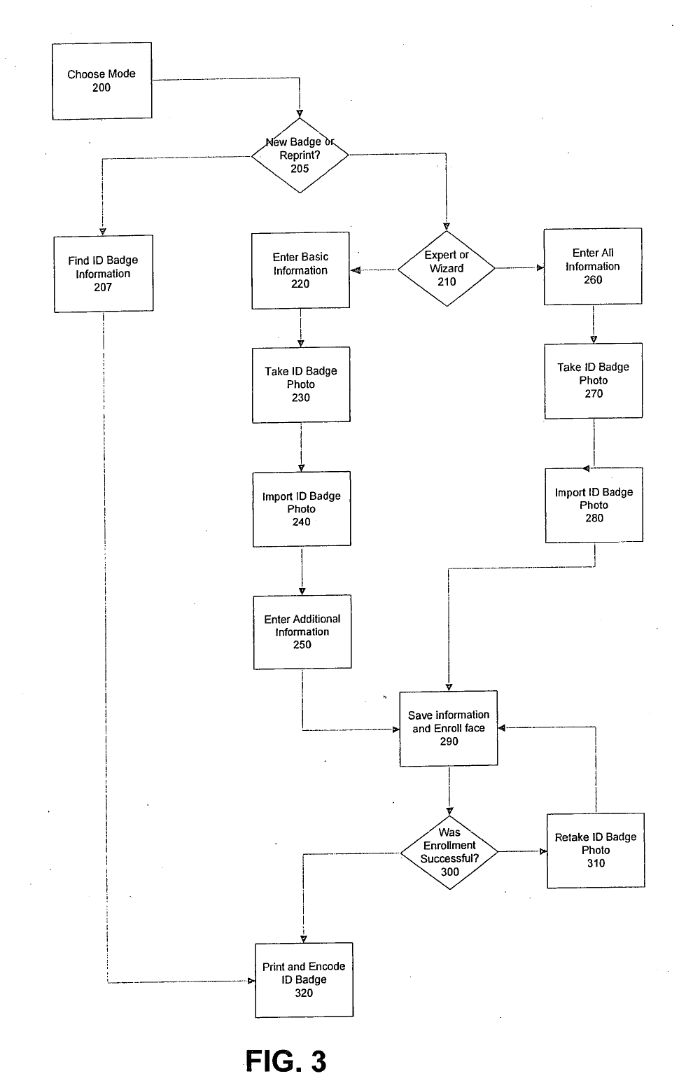

FIG. 3 shows the process implemented by the system for creating an ID badge. The first step in the process 200 is to determine if a new ID badge or a reprint of an existing ID badge is needed 205. If a reprint of an existing ID badge is needed the existing information needs to be found in the database. If a new ID badge is needed, the user of the system can choose either the wizard mode or the expert mode 210.

In wizard mode, the process is followed step by step. The first step is to enter basic information 220 about the person who needs an ID badge. The basic information includes the person's name, employee number and Social Security Number. The next step is to take the person's digital image 230 with the still digital camera and import the image into the badge printing application 240. Lastly, the wizard allows the user to enter additional information about the person 250. This includes the person's address as well as any other optional information that is desired.

In the expert mode, all of the person's information is entered on a single screen 260. As in wizard mode, the person's digital image is taken 270 and imported into the badge printing application 280. In either wizard mode or expert mode, once all the information is collected and the person's digital image is taken and imported into the application, the photo is enrolled into the biometric database and the person's information is saved to the database 290. If the enrollment process fails 300, the person's digital image is retaken 310 and re-enrolled. This process is repeated until the enrollment process is successful. After the information is saved and enrollment is successful, the ID badge is printed and encoded 320 using the ID badge printer.

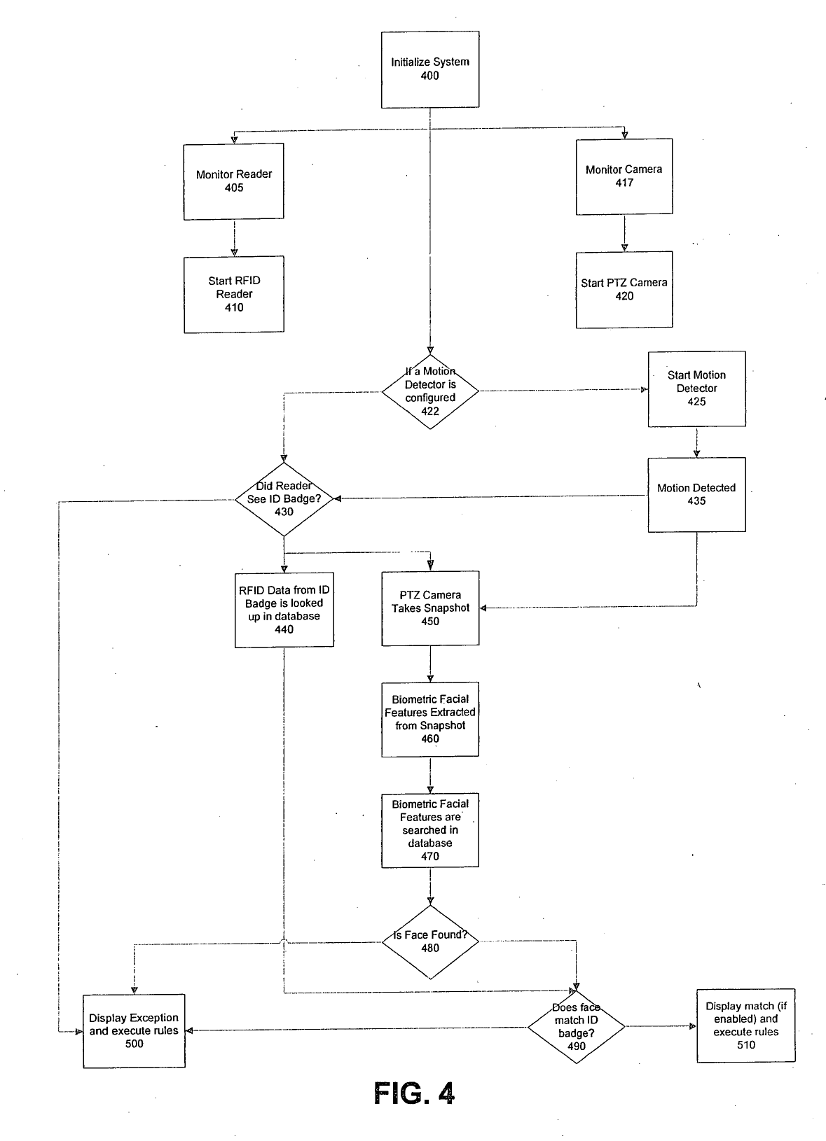

FIG. 4 shows how the system monitors a security zone. When the system is initialized 400, the connected devices are checked to ensure they are online. The user is then able to monitor the PTZ camera(s) 417 as well as start the PTZ camera(s) 420. The RFID reader(s) 405 can also be monitored and Started 410. If a motion detector 425 is present, either as a component of the PTZ camera or as a stand alone component it is also started.

The main function of the system starts when either motion is detected 435 by a motion detector 425 or in the case there is no motion detector, when a RFID reader sees a RFID tag 430. If a motion detector is present and it sees motion, the motion triggers a snapshot to be taken by the PTZ camera 450 and a read to be taken by the RFID reader 430. The read at the reader is looked up in the database 440. At the same time the facial features are extracted from the snapshot 460 and searched in the database for a match 470. If a valid ID badge has been seen by the reader and the face detected 480 in the snapshot matches the holder of the ID badge 490, then a match is found and the system executes the rules specified for good matches 500. If for any reason a match is not made, a RFID ID badge is not seen, a face is not seen, or the face seen does not match the ID badge read, then an exception occurs and the rules around the exception are processed and the exception is displayed 510 by the system.

The system runs four separate, but cooperative threads: motion detection, RFID tag reads, people counting and biometric facial matching. When the system is running, the motion detection and RFID tag read threads are constantly watching for motion and RFID tag reads respectively. The main processing of the system's matching ID badges to matched faces starts when either the motion detector sees motion or the RFID reader sees an ID badge. When either of these two events occurs, the system begins to attempt to match the faces being seen by the PTZ camera(s) to the ID badges being seen by the reader. The first step in this process is to start the camera taking snapshot images. Each face in each image is counted and then attempted to be matched to enrolled images. For each face found in each snapshot and for each ID badge read by the reader an attempt is made to match the face to the ID badge. If the ID badge is known to the system and that person's face has been seen and matched to the enrolled image, then there is no exception and the system continues it's processing. If either the face cannot be matched to an enrolled image or the ID badge for a matched face is not read by the reader, then an exception condition exists. For all exceptions, the computer system displays the appropriate information to the user. Each exception condition is color coded. The light stack is used to provide visual indication for both normal and exception conditions.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

1. A biometric identification system as claimed in claim 20 wherein said camera has a motion sensor which activates the camera to take a digital picture.

2. A biometric identification system as claimed in claim 20 wherein said system includes a light stack connected to a computer which provides visual feedback for facial matches and mismatches.

3. A biometric identification system as claimed in claim 2 wherein said light stack flashes a plurality of different colors to denote matches and mismatches.

4. A biometric identification system as claimed in claim 3 where said light stack has an audio device which sounds for mismatches.

5. A biometric identification system as claimed in claim 20 wherein said system includes a light stack which provides visual feedback for RFID tag matches and RFID tag mismatches.

6. A biometric identification system as claimed in claim 5 wherein said light stack flashes a plurality of different colors to denote matches and mismatches.

7. A biometric identification system as claimed in claim 6 where said light stack has an audio device which emits an audio signal for mismatches.

8. A biometric identification system as claimed in claim 20 wherein said system includes a printer for printing an identification card with an RFID tag directed toward a specific identification card carrier and a camera which records a picture of said identification card holder, said picture being printed on said identifying card and a digital facial image of said card holder being transmitted to said data storage means.

9. A biometric identification system as claimed in claim 20 wherein said system includes a first fixed camera which includes the camera's IP address as well as a directory used to store pictures taken by the camera during regular operation of the camera.

10. A biometric identification system as claimed in claim 20 including a badge printing assembly comprising a fixed camera and a printer which prints an identification card with a picture of a identification card holder.

11. A biometric identification system as claimed in claim 2 wherein said light stack operates a door latch which will be closed if there is a mismatch.

12. A biometric identification card system as claimed in claim 20 wherein said first set of biometric information includes the card holder's name, social security number and employee number.

13. A biometric identification method, comprising:
a. activating a biometric identification card by digitally photographing a face of a person and transmitting the photographed facial digital data to a database while printing the photograph of the person on a identification card, and assigning identification information criteria relating to said person in an RFID tag secured to said identification card;
b. transmitting said identification information to a data base;
c. subsequently reading the information from the RFID tag on said identification card at a location remote from the said activation;
d. digitally photographing the facial feature of a person carrying said identification card as part of an access transaction to obtain a comparison set of biometric information; and
e. determining whether the set of RFID tag information and digital photograph biometric information is a match of said stored biometric information obtained during said biometric identification card activation.

14. A biometric identification method as claimed in claim 13 wherein additional biometric information of the person activating the biometric identification card is added to said RFID tag on said identification card by a printer when said identification card is being created and activated.

15. An identity checking method for verifying the identity of an individual comprising the steps of:
a. capturing an individual's digital facial data at an initial time and storing it on a first database;
b. associating said initial digital facial data with a unique description stored in said first database and encoded in a RFID tag embedded on an identify card issued to the individual;
c. capturing contemporary facial data and said unique description by remote sensing means at a point of arrival of said individual;
d. interrogating said first database for said initial facial data corresponding to said captured unique description;
e. comparing said contemporary facial data with said corresponding initial biometric data; and
f. making a decision on the basis of the degree of correlation in step (e) to allow entry of said individual into a specific area.

17. A method as claimed in claim 15 wherein said first database includes protected identification data specific to the appearance and specific identify of an individual.

18. A method of verifying identity of an individual comprising the steps of:
a. initially photographing an individual to obtain facial data and unique identifying data for storage in an originating database;
b. creating, for each individual a remotely readable document with unique identifying data in the form of an RFID tag and the facial data stored in said originating database corresponding to the individual for whom the document was created; and
c. comparing directly observed biometric facial and unique data at a remote entry point retrieved from said document and a digital camera which can take facial data at said entrance point with facial data and unique identifying data in said database to determine if the data matches to allow the individual entry into designated areas.

18. A method as claimed in claim 17 wherein said RFID tag is read by a RFID reader at said remote entry point.

19. A security system comprising an identification card with an RFID tag secured thereto, a biometric database containing a digital facial image of an identification card carrier and RFID tag information of the identification card carrier, a remote RFID reader sensing and reading said identification card with said RFID tag and relaying said tag information to a computer, a remote digital video surveillance camera which records the facial digital image of the identification card holder and transmits the facial digital image to a computer which accesses said database and compares the facial digital image record taken by said digital video surveillance camera with said digital facial image in said biometric database identified in said database by the identification card RFID tag to determine if there is a match to verify the identification card carrier.

20. A biometric identification system, comprising: a UHF radio frequency identification (RFID) tag secured on an identification card storing a first set of biometric information which corresponds to a specific identification card holder; data storage means storing said first set of biometric information and a second set of biometric information representing the facial digital image of said holder of said identification card, a remote RFID reader using radio frequency signals to read the first set of biometric information from said RFID tag secured to said identification card and transmit the first set of biometric information to a computer, a remote camera which digitalizes the facial features of the identification card carrier sensed by the RFID reader and comparison means which compares the biometric information received from the identification card by said remote reader to said stored first set of biometric information in said data storage means and compare said digital facial image captured by said remote camera to the second set of digital facial information in said data storage means to determine if the two sets of biometric facial information are a match.
